(19) United States
(12) Patent Application Publication
(10) Pub. No.: US 2026/0257389 A1
(43) Pub. Date: Sep. 3, 2026

(54) KNIFE AND SHEATH SYSTEM

(71) Applicant: Scabbard Knives LLC, LANCASTER, KY (US)

(72) Inventors: Michael Ray McDonald, LANCASTER, KY (US); Andrew Taylor Grace, Nicholasville, KY (US)

(73) Assignee: Scabbard Knives LLC, LANCASTER, KY (US)

(21) Appl. No.: 19/546,359

(22) Filed: Feb. 22, 2026

Related U.S. Application Data
(60) Provisional application No. 63/765,705, filed on Mar. 2, 2025.

(51) Int. Cl. B26B 29/02; B26B 3/06

(52) U.S. Cl. CPC B26B 29/025; B26B 3/06

(57) ABSTRACT

A sheath and knife system includes a sheath and a knife. The sheath includes at least one follower element biased by a resilient flexible element. The knife includes a retention element on a blade portion configured to engage the follower element such that the knife is retained within the sheath without locking. In some embodiments, the follower element includes entry and exit ramp features configured to store spring energy during insertion and release the spring energy to assist retention and removal. The sheath may define a retention element slot configured to receive the retention element and constrain relative vertical movement. In some embodiments, the sheath defines a clipping space with at least one resilient flexible element configured to bias a clipping material. In some embodiments, at least one roller rotates upon engagement with a blade bevel to reduce friction.

### CROSS-REFERENCE TO RELATED APPLICATION

This application claims the benefit of U.S. Provisional Patent Application No. 63/765,705 filed on Mar. 2, 2025, entitled “Knife and Sheath System,” which is hereby incorporated by reference in its entirety for all that is taught and disclosed therein.

### FIELD OF THE INVENTION

The present invention relates to knives and sheaths, and more particularly to sheaths for fixed blade knives.

### BACKGROUND

Fixed blade knives are commonly paired with sheaths that protect the blade's sharp edge when not in use. Traditionally, these sheaths are made from materials such as leather or plastic. These materials are favored because of their softer nature which minimizes the risk of dulling the blade.

Conventional retention methods differ based on the sheath material. In leather sheaths, a buttoned strap or friction alone is often used to secure the knife. In contrast, many plastic sheaths are molded with a slight interference fit that requires the material to flex as the knife is inserted or withdrawn. However, these approaches can demand extra undesired effort from the user, sometimes complicating the smooth and rapid deployment or return of the knife.

Furthermore, fixed blade knives are typically carried attached to a belt or worn on the exterior of pants near the waist. For smaller knives, a more discreet carrying option, such as placement in a pant pocket, is often preferred. Yet, traditional leather sheaths can be bulky and uncomfortable in a pocket, while more compact plastic sheaths may lack an effective means of securing the sheath, making it difficult for the user to locate and retrieve the sheath quickly.

### SUMMARY OF THE INVENTION

There has long been a need for a new and improved knife and sheath system that overcomes the conceptual deficiencies and inconveniences of conventional designs. The present invention substantially departs from prior art by providing a novel apparatus that addresses these shortcomings and offers enhanced retention, smooth operation, and versatile mounting options.

In one embodiment, the system comprises a sheath that includes at least one follower element biased by a resilient flexible element. This configuration cooperates with a retention element protruding from the knife's blade portion such that the follower element retains the retention element without locking it. This design not only secures the knife within the sheath but also facilitates easy insertion and removal.

In another embodiment, the invention provides a sheath with an integrated clipping mechanism. The sheath features a cover portion and an exterior shelf portion that together define a clipping space adapted to receive a clipping material such as a sheet-like or strap-like material, whether wearable or stationary. Within this space, at least one resilient flexible element biases the clipping material into engagement with one or both of the cover portion and the shelf portion, thereby retaining the sheath on the user's clothing or accessory.

Additionally, another embodiment of the invention comprises a sheath having an opening for receiving the knife's blade portion, with at least one roller disposed within this opening. As the knife is inserted into and withdrawn from the sheath, the roller rotates upon engagement with the blade, ensuring smooth operation and protecting the blade's cutting edge.

Overall, the present invention provides an improved knife and sheath system that not only overcomes the disadvantages of conventional designs but also offers multiple embodiments tailored for enhanced functionality and user convenience. Further details, features, and advantages of the invention are described herein and illustrated in the accompanying drawings, thereby contributing a significant advancement to the art.

In some embodiments, the sheath includes any combination of (i) a follower/retention subsystem, (ii) a clipping subsystem, and (iii) a roller guidance subsystem. These subsystems may share common structure (including covers, bases, and a base frame) and cooperate to improve retention, deployment, and carry, such that the disclosed embodiments describe a unified knife-and-sheath platform configurable with different feature sets.

### BRIEF DESCRIPTION OF THE DRAWINGS

FIG. 1A is a top right isometric view of the right side of an embodiment of a knife and sheath constructed in accordance with the principles of the present invention.

FIG. 1B is a bottom view of the knife and sheath in FIG. 1A.

FIG. 2A is a top right isometric view of the front end of the sheath of FIG. 1A.

FIG. 2B is a top left isometric view of the rear end of the sheath of FIG. 1A.

FIG. 3A is a front view of the right side of the knife of FIG. 1A.

FIG. 3B is a top right isometric view of the rear end of the knife of FIG. 1A.

FIG. 4A is a top right exploded isometric view of the front end of the sheath of FIG. 1A.

FIG. 4B is a top right exploded isometric view of the front end of the knife of FIG. 1A.

FIG. 5 is a top right isometric view of the left side of the center base of the sheath of FIG. 1A.

FIG. 6A is a bottom right isometric view of the front end of the base frame of the sheath of FIG. 1A.

FIG. 6B is a top left isometric view of the rear end of the base frame of the sheath of FIG. 1A.

FIG. 7A is a front view of the left side of the right base of the sheath of FIG. 1A.

FIG. 7B is a top right isometric view of the left side of the right base of the sheath of FIG. 1A.

FIG. 8A is a top left isometric view of the rear end of the sheath of FIG. 1A showing only the base frame, right roller, right base, and right cover.

FIG. 8B is a front view of the left side of the sheath of FIG. 1A showing only the base frame, right roller, and right base.

FIG. 9 is a cross-section view of the sheath of FIG. 1A showing the right base, left base, rollers, and blade.

FIG. 10 is a side view of the retention components of the knife and sheath of FIG. 1A.

FIG. 11 is a side view of the retention components of the sheath of FIG. 1A.

FIG. 12A is a top right isometric view of the front end of the right cover of the sheath of FIG. 1A.

FIG. 12B is a top view of the sheath of FIG. 1A.

The same reference numerals refer to the same parts throughout the various figures.

### DEFINITIONS

As used herein, the singular forms “a,” “an,” and “the” include plural referents unless the context clearly indicates otherwise. The terms “comprising,” “including,” and “having” are open-ended and do not exclude additional elements or steps.

As used herein, “knife” includes fixed-blade knives and other bladed tools having a blade portion and a handle portion. “Sheath” includes housings, scabbards, carriers, and similar structures configured to at least partially receive and cover a blade portion.

As used herein, “follower element” includes a member configured to engage a retention element of a knife, including sliding, pivoting, rolling, or flexing members, and may include one or more ramp features, tips, or contact features.

As used herein, “resilient flexible element” includes springs and spring-like members (including cantilever springs) that store and release elastic energy and may be integral with a component or separately formed and attached to a component.

As used herein, “retention element” includes a protrusion, pin, boss, stud, or other feature extending from the blade portion and configured to engage one or more follower elements. A retention element may be integrally formed with the blade portion or separately formed and attached to the blade portion.

As used herein, “without locking” means retention is provided without a user-actuated lock that must be moved to a locked state to prevent withdrawal; and without requiring a separate locking operation to transition between locked and unlocked states; however, optional embodiments may include locking mechanisms.

### Description of a Current Embodiment

An embodiment of the knife and sheath is shown and generally designated by the reference numeral 100.

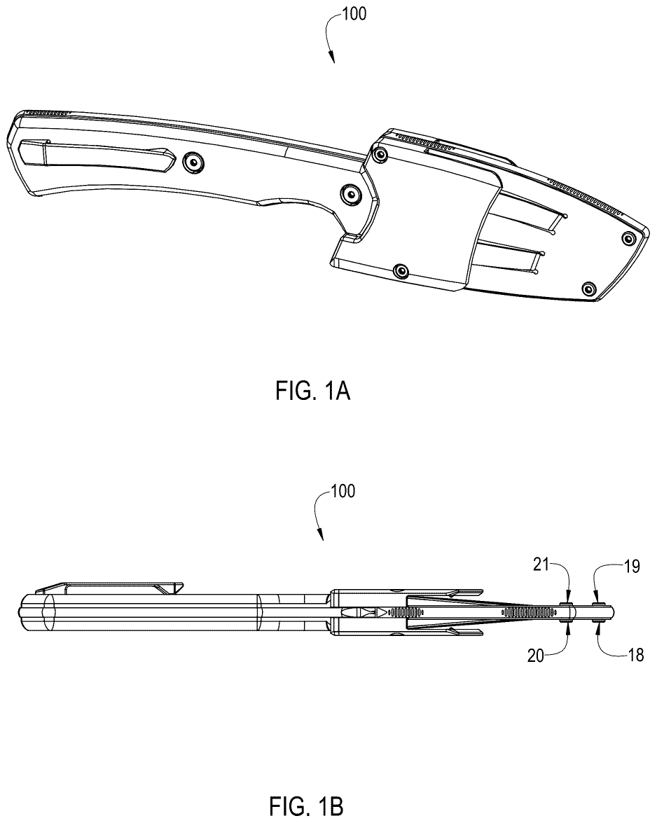

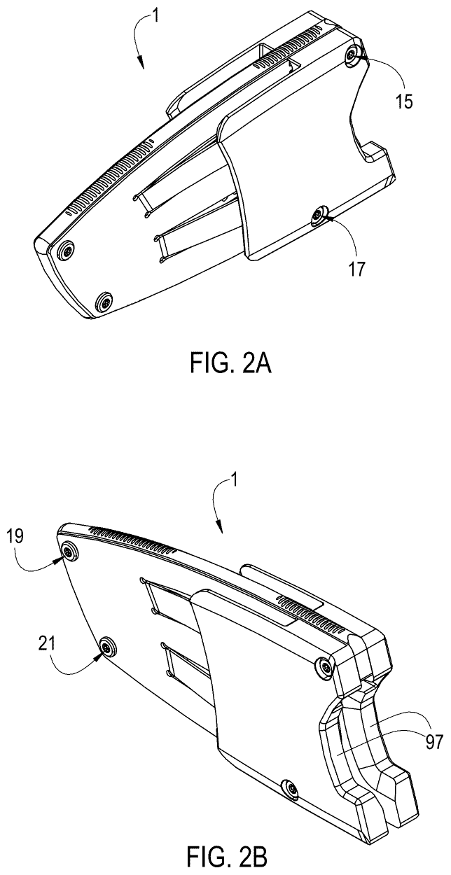

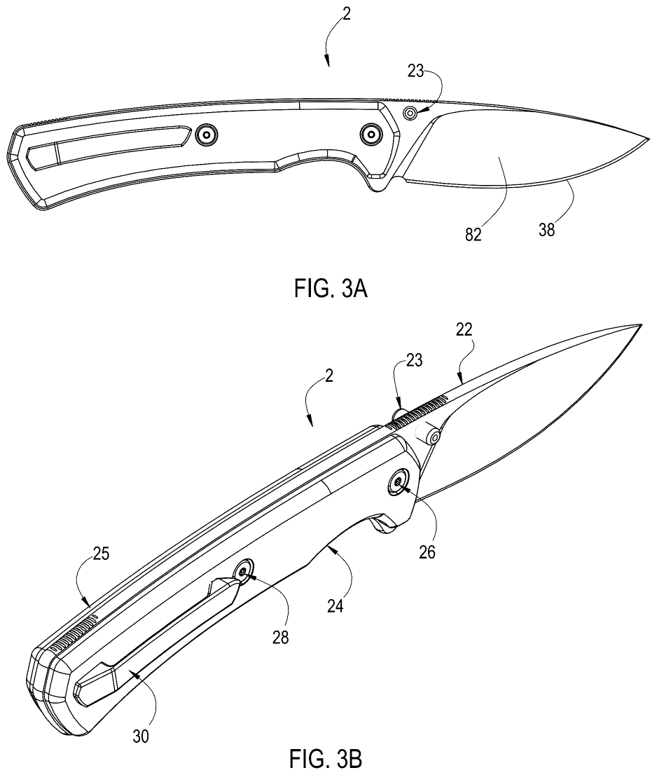

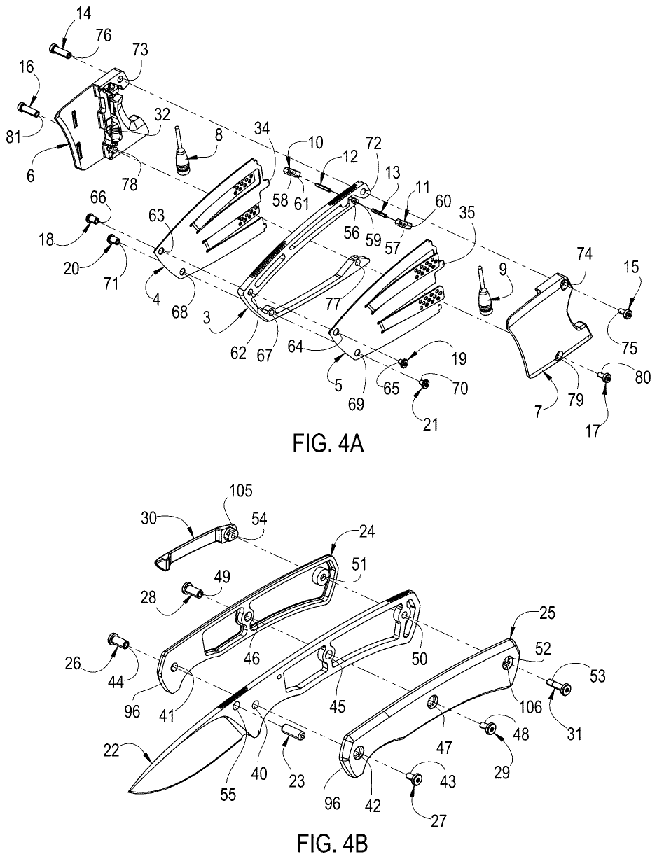

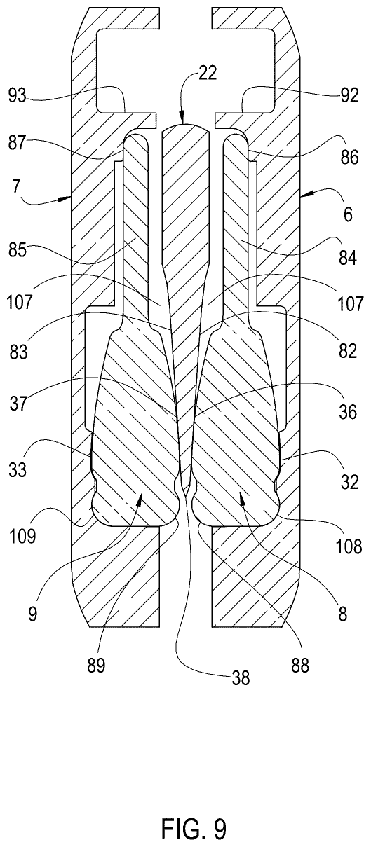

FIG. 1A, FIG. 1B, and FIG. 4 illustrate the knife and sheath 100. The knife and sheath 100 in FIG. 1A depicts the full assembly. A sheath 1 is shown in FIGS. 2A and 2B. A knife 2 is shown in FIGS. 3A and 3B. An opening 107 of the sheath 1 receives the knife 2 (see FIG. 1A and FIG. 9). For clarity, reference numeral 100 refers to the overall system/assembly, while reference numerals 1 and 2 refer to the sheath and knife, respectively.

FIG. 4A illustrates an exploded view of the sheath 1. The sheath 1 components include a center base 3, a right cover 4, a left cover 5, a right base 6, a left base 7, a right roller 8, a left roller 9, a right follower element 10, a left follower element 11, an upper follower pin 12, a lower follower pin 13, an upper base barrel 14, an upper base screw 15, a lower base barrel 16, a lower base screw 17, an upper cover barrel 18, an upper cover screw 19, a lower cover barrel 20, and a lower cover screw 21.

FIG. 4B illustrates an exploded view of the knife 2. The knife 2 components include a knife base 22, a retention element 23, a right scale 24, a left scale 25, a front handle barrel 26, a front handle screw 27, a middle handle barrel 28, a middle handle screw 29, a pocket clip 30, and a pocket clip screw 31.

The right scale 24 and left scale 25 are clamped to the knife base 22 by the front handle barrel 26, front handle screw 27, middle handle barrel 28, middle handle screw 29, pocket clip 30, and pocket clip screw 31. The front handle barrel 26 and front handle screw 27 extend into a front knife base scale hole 40, a front right scale hole 41, and a front left scale hole 42. A front handle screw male thread feature 43 of the front handle screw 27 is received by a front handle barrel female thread feature 44 of the front handle barrel 26. The middle handle barrel 28 and middle handle screw 29 extend into a middle knife base scale hole 45, a middle right scale hole 46, and a middle left scale hole 47. A middle handle screw male thread feature 48 of the middle handle screw 28 is received by a middle handle barrel female thread feature 49 of the middle handle barrel 29. The pocket clip 30 and pocket clip screw 31 extend into a rear knife base scale hole 50, a rear right scale hole 51, and a rear left scale hole 52. A pocket clip screw male thread feature 53 of the pocket clip screw 31 is received by a pocket clip female thread feature 54 of the pocket clip 30. The pocket clip 30 and pocket clip screw 31 are reversible allowing the pocket clip 30 to be mounted on the right scale 24 or the left scale 25. The left scale 25 and right scale 24 both have a pocket clip orientation slot feature 106. The pocket clip orientation boss feature 105 is received by the pocket clip orientation slot feature 106 of the right scale 24 or left scale 25 which controls the orientation of the pocket clip 30 (see FIG. 4B). The use of a pocket clip on a fixed blade allows for a deep carry position within a pant pocket which is often desired for a more discrete carry mode. Other embodiments may utilize pins, adhesive materials, or other fastening methods to attach the scales to the knife base instead of using threaded components. Other embodiments may have scale features that are integral to the knife base.

The tang portion of the knife base 22 is the portion of the knife base 22 between the right scale 24 and left scale 25. The right scale 24, the left scale 25, and the tang portion of the knife base 22 define a handle portion of the knife 2 (See FIG. 4B and FIG. 3B). The portion of the knife base 22 that is not between the right scale 24 and left scale 25 defines a blade portion of the knife 2. In other embodiments that do not include a left and right scale, the handle portion may be defined as the portion of the knife that is intended to be gripped during typical usage of the knife and the portion not gripped during typical usage may define the blade portion.

The retention element 23 is removably secured into the blade portion by press fit into the blade retention element hole 55 (See FIG. 4B). The retention element 23 is a single component in the current embodiment. Other embodiments of the retention element 23 may include two components that join together instead of a single component. Two-component embodiments of a retention element may include two components that screw together or two components that press together or two components that press into the blade portion. The retention element 23 does not directly contact or connect to the right scale 24 or the left scale 25 or handle portion(See FIG. 3A and FIG. 3B). The retention element 23 of the current embodiment protrudes from both sides of the blade portion. Other embodiments may include a retention element that protrudes from only one side of the blade portion or may protrude more on one side than the other side of the blade portion. In other embodiments, the retention element 23 may also be integral to the blade portion or bonded to the blade portion with adhesive materials.

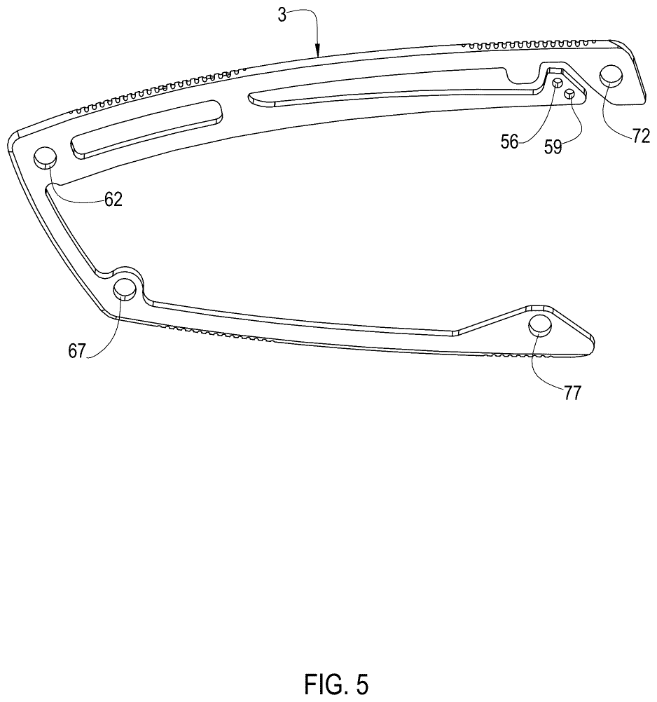

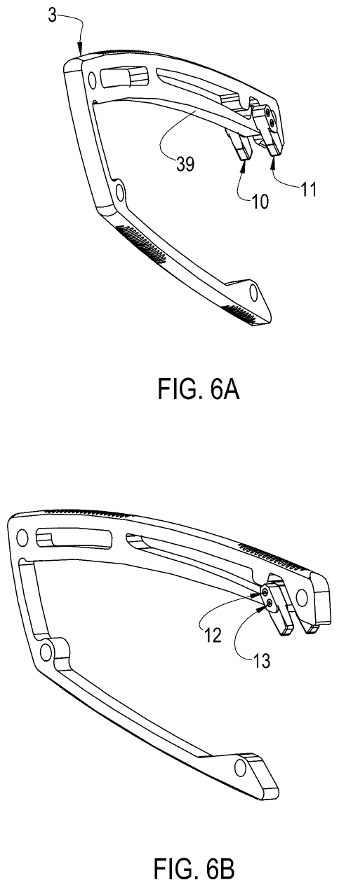

The upper follower pin 12 is pressed into a center base upper follower hole 56, an upper left follower hole 57, and an upper right follower hole 58. The lower follower pin 13 is pressed into a center base lower follower hole 59, a lower left follower hole 60, and a lower right follower hole 61. The left follower element 11, right follower element 10, center base 3, upper follower pin 12, and lower follower pin 13 define a base frame of the current embodiment (see FIG. 4A, FIG. 5, FIG. 6A, and FIG. 6B). Other embodiments of the base frame may include screws to fasten the left follower element 11 and right follower element 10 to the center base 3. Other embodiments may include only the left follower element 11 or the right follower element 10. The follower elements and retention element may all be machined components with high quality surface finishes to promote precise and smooth engagement to enhance the user experience which is an improvement over conventional leather and plastic sheaths. Other embodiments of the base frame may utilize a follower that is integral or bonded to the center base. Another embodiment of the followers may have features that allow them to be pressed directly to the center base thereby eliminating the need for follower pins. Other embodiments of the followers may have features that allow one follower to be fastened or pinned directly to another follower. Another embodiment may have a follower that has the features of both the right follower and left follower. Other embodiments of the follower may utilize a single fastener or pin for attachment instead of two or more fastening components.

The right cover 4 and left cover 5 are clamped to the base frame by the upper cover barrel 18, upper cover screw 19, lower cover barrel 20, and lower cover screw 21. The upper cover barrel 18 and upper cover screw 19 extend into an upper center base cover hole 62, an upper right cover hole 63, and an upper left cover hole 64. An upper cover screw male thread feature 65 of the upper cover screw 19 is received by an upper cover barrel female thread feature 66 of the upper cover barrel 18. The lower cover barrel 20 and lower cover screw 21 extend into a lower center base cover hole 67, a lower right cover hole 68, and a lower left cover hole 69. A lower cover screw male thread feature 70 of the lower cover screw 21 is received by a lower cover barrel female thread feature 71 of the lower cover barrel 20. (see FIG. 4A, FIG. 5, FIG. 1B, and FIG. 2B). Other embodiments may include only the left cover or right cover. Another embodiment may use pins or adhesives to fasten covers to the center base. In other embodiments the left and right covers may be combined into a single component rather than two. Another embodiment may utilize cover features that are integral to the base frame.

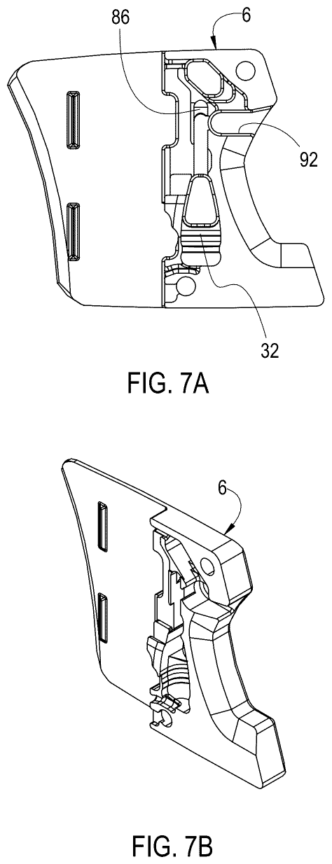

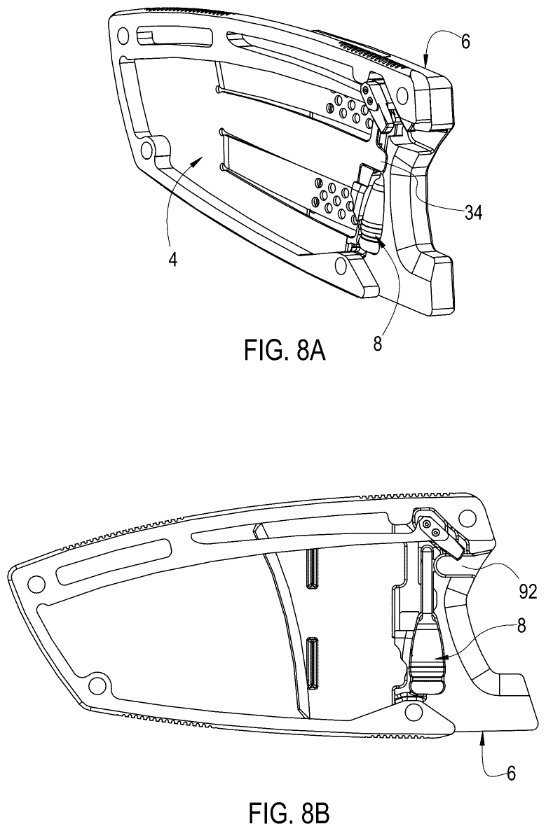

FIG. 7A and FIG. 7B illustrate the right base 6. In one embodiment, the sheath defines a roller pocket configured to receive a roller, and a cover portion comprises a retainer tab configured to retain the roller within the roller pocket. In the current embodiment, the right roller 8 is received by and able to rotate within a right roller pocket feature 32 of the right base 6 (See FIG. 4A and FIG. 7A). The left roller 9 is received by and able to rotate within a left roller pocket feature 33 of the left base 7. A cross-section view of the sheath 1 is shown in FIG. 9 which depicts the right roller 8 and left roller 9 residing within the roller pocket features of the right base 6 and left base 7. The right roller 8 is retained within the right roller pocket feature 32 by a roller retainer tab feature 34 of the right cover 4 (see FIG. 8A). The left roller 9 is retained within the left roller pocket feature 33 by a roller retainer tab feature 35 of the left cover 5 (see FIG. 4A). In the current embodiment the left base 7 is a mirrored component of the right base 6 and the left cover 5 is a mirrored component of the right cover 4. Other embodiments may utilize non-mirrored components. Other embodiments may retain the rollers into the roller pockets by the base frame, or by additional components that may be fastened, bonded, or press fit to the base frame or right or left bases.

The right base 6 and left base 7 are clamped to the base frame by the upper base barrel 14, upper base screw 15, lower base barrel 16, and lower base screw 17. The upper base barrel 14 and upper base screw 15 extend into an upper center base hole 72, an upper right base hole 73, and an upper left base hole 74. An upper base screw male thread feature 75 of the upper base screw 15 is received by an upper base barrel female thread feature 76 of the upper base barrel 14. The lower base barrel 16 and lower base screw 17 extend into a lower center base hole 77, a lower right base hole 78, and a lower left base hole 79. A lower base screw male thread feature 80 of the lower base screw 17 is received by a lower base barrel female thread feature 81 of the lower base barrel 16. (see FIG. 4A, FIG. 5, and FIG. 2A). Other embodiments of the right and left bases may be pressed, or pinned, or bonded to the base frame. Another embodiment may have either the right or left base integral to the base frame. Other embodiments may have a single component that encompasses the features of both the right and left base, while another embodiment may be configured such that the left and right base are fastened directly together with pins or screws.

When the blade portion of knife 2 is inserted into the opening 107 of sheath 1, a right blade bevel 82 and a left blade bevel 83 of the blade portion may contact the right roller 8 and the left roller 9 causing the rollers to rotate. Knife bevels are typically tapered, or angled, such that the blade's cross section gradually reduces toward the cutting edge. In other words, the blade is thicker at the spine of the blade than at the cutting edge of the blade. The bevels are what give a knife blade a wedge shape which is a unique distinction as compared to saws. Saws do not have bevels (i.e., reducing cross sections) or wedge shapes like knives. A blade contact surface 36 of the right roller 8 and a blade contact surface 37 of the left roller 9 provide a guiding function that protects a blade cutting edge 38 as the blade portion enters the sheath 1 (see FIG. 9 and FIG. 3A). The rollers are free to rotate which permits a smooth and low friction surface to guide the blade portion into and out of the sheath 1 (see FIG. 9). The smoothness of insertion and withdrawal provides a better experience for the user with less effort compared to the excessive drag that is inherent with traditional leather and plastic sheaths. During insertion and withdrawal of the knife 2 into and out of the sheath 1, the blade portion is constrained vertically from the bottom by the rollers and from the top by a blade spine guide surface 39 (see FIG. 6A). A predetermined amount of clearance is provided to prevent over-constraining the knife vertically within the sheath.

The unique challenge presented when sliding a wedge-shaped blade between opposing rollers is the risk of wedge locking. Wedge locking occurs when frictional forces between the wedge and the mating surfaces increase to a level that prevents further movement, effectively pinching the blade such that it can no longer translate within the sheath. The current embodiment is configured to mitigate this potential for wedge locking or binding. The right roller 8 has a right roller stem feature 84 and the left roller 9 has a left roller stem feature 85. The end portion of the right roller stem feature 84 is supported by a right roller stem support feature 86 of the right base 6. The end portion of the left roller stem feature 85 is supported by a left roller stem support feature 87 of the left base 7 (see FIG. 9 and FIG. 7A). The stem portions of the rollers are slender to allow flexure to accommodate blade thickness variation and to prevent binding the blade portion during insertion and withdrawal from the sheath 1. The right roller 8 has a right roller pivot head 88 and the left roller 9 has a left roller pivot head 89. The pivot heads portions of the rollers have a round shape and allow the rollers to pivot in a right roller pocket pivot feature 108 and a left roller pocket pivot feature 109 (see FIG. 9). The pivoting capability reduces stress in the roller stem features when they flex. The right roller 8 and the left roller 9 are identical in this embodiment but may differ in other embodiments. Roller materials may include polymers such as acetal and metals such as bronze to provide a smooth and low-friction user experience. Other embodiments may include other alloys or other types of synthetic or natural materials. Other embodiments may use a single roller instead of two rollers. Furthermore, other embodiments may use more than two rollers. Additionally, other embodiments may stagger the positioning of the rollers such that they are not directly across from one another. A roller may also be positioned under or over the blade portion instead of positioning the rollers at either side of the blade portion. Since the rollers may be made of materials soft in nature and shaped to protect the blade cutting edge 38, this allows other components such as the bases and covers of the sheath 1 to be made of harder materials such as titanium, stainless steel, or other premium materials not typically used in conventional leather and plastic sheaths. Other embodiments may utilize additional components such as bearings or bushings to further support and reduce friction during roller rotations.

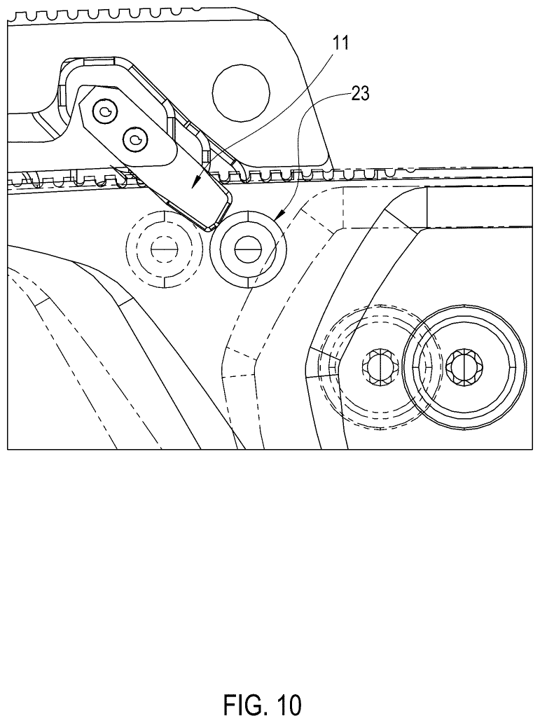

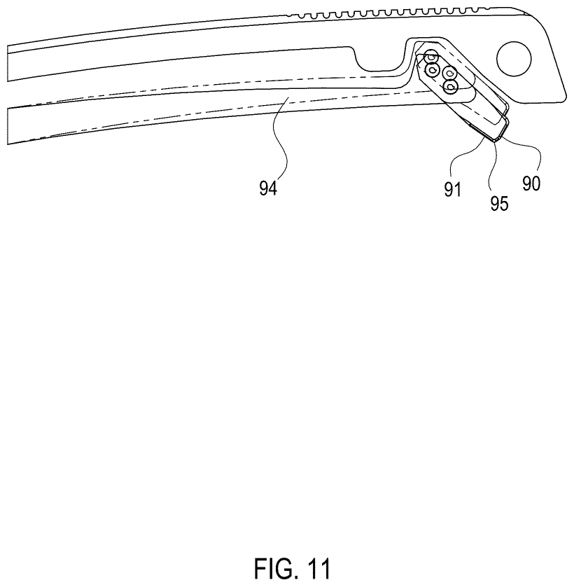

FIG. 10 illustrates the retention mechanism of the knife and sheath 100 as the retention element 23 of the knife 2 contacts the followers of the base frame. During insertion of the knife 2 into the sheath 1, the retention element 23 first enters a right retention element slot 92 (see FIG. 7A and FIG. 9) and a left retention element slot 93 (see FIG. 9). The retention element slots are closely fitted to the size of the retention element 23 to minimize relative vertical movement of the retention element within the slots. In other words, the retention element slots are sized to constrain relative vertical movement of the retention element within the slots during insertion and withdrawal. Both the right follower element 10 and the left follower element 11 have an entry ramp feature 90 and an exit ramp feature 91 (see FIG. 11). Other embodiments may have different entry and exit ramps features on each follower. The entry and exit ramp features of the followers may be linear or curvilinear or a combination of both in other embodiments. As the retention element 23 continues to move forward within the retention element slots, the retention element 23 contacts the entry ramp features 90 which cause the followers to move upward by elastically bending a base frame resilient flexible element 94 upward like a cantilever spring. Once the retention element 23 crosses the follower tips 95 (see FIG. 11), the followers then begin to lower back down vertically, while in continuous contact with the retention element 23, due to the spring energy stored from the base frame resilient flexible element's 94 displacement during the entry ramp contact movement. This stored spring energy acting downward through the exit ramp features 91 onto the retention element 23 is the retention force used to retain the knife 2 into the sheath 1. The horizontal component of the retention force pushes the retention element 23 forward until a front scale feature 96 of the right scale 24 and/or left scale 25 contacts a scale stop feature 97 of the right base 6 and/or left base 7 (see FIG. 2B and FIG. 4B). The stop feature is positioned to contact a scale feature of the knife to limit forward movement of the knife within the sheath. Other embodiments may utilize the end of the retention element slots to prevent further forward movement of the retention element 23. While the base frame resilient flexible element 94 is integral to the base frame in the current embodiment, other embodiments may be configured to use a non-integral base frame resilient flexible element, one that is fastened, or pinned, or bonded, or pressed to the center base. Another embodiment may utilize a follower that contacts the bottom surface of the retention element for which the base frame resilient flexible element responds in the opposite direction than in the current embodiment.

As the knife 2 is removed from the sheath 1 by the user, the retention element 23 moves rearward maintaining contact with the exit ramp features 91 causing the followers to move upward creating spring energy in the base frame resilient flexible element 94. As the retention element 23 crosses the follower tips 95, the spring energy begins to release as the retention element continues rearward in contact with the entry ramp features 90. The horizontal component of the force of the followers acting on the retention element 23 pushes the element rearward to assist in removing the knife 2 from the sheath 1. Once the retention element crosses the follower tips in either direction, the spring energy assists to push the knife into the sheath during insertion and assists to push the knife out of the sheath during withdrawal. This assistance provides a snap-in and snap-out feeling to the user which is often left to be desired with the traditional retention methods of conventional plastic and leather sheaths.

Other embodiments of the right follower element 10 and left follower element 11 may include rollers at the tips of the followers to further reduce friction. Another embodiment may have a retention element that is a rolling element that rotates to reduce friction. Other embodiments of the knife and sheath 100 may include locking mechanisms to lock the knife 2 into the sheath 1. An embodiment of a locking mechanism may utilize a locking element that engages the retention element 23 to prevent rearward movement. Another embodiment of a locking mechanism may utilize a locking element that acts on the base frame by preventing upward movement of the base frame resilient flexible element 94.

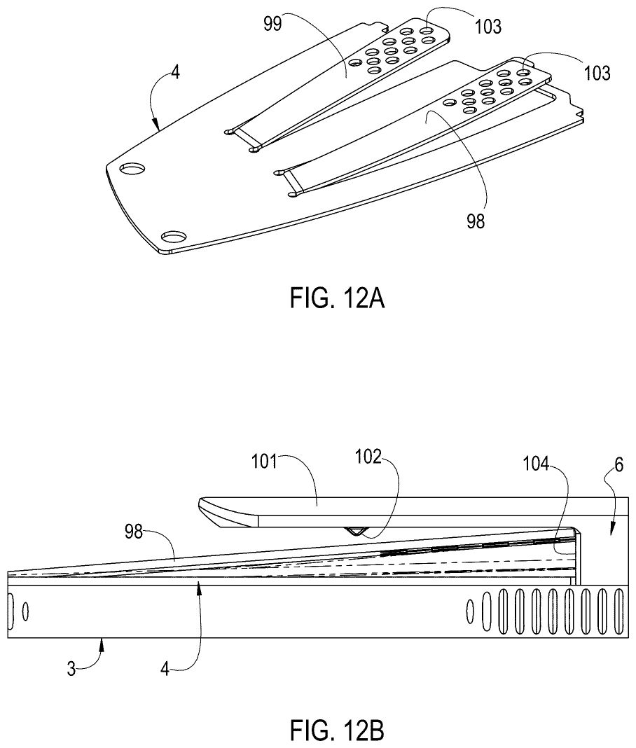

The right cover 4 comprises the right cover portion of the sheath 1 and the left cover 5 comprises the left cover portion of the sheath 1. The left and right cover portions have the primary purpose of covering the blade cutting edge 38 of the knife base 22. The covers also have a secondary purpose. FIG. 12A illustrates the right cover 4 and FIG. 12B illustrates the right cover 4 and the right base 6 assembled together which comprise a sheath clipping mechanism. The sheath clipping mechanism can be used to fasten the sheath 1 to items such as a pant pocket, a pant belt loop, a belt, a backpack, or any suitable sheet-like or strap-like material, whether wearable or stationary. The right cover 4 and the left cover 5 both have an upper cover resilient flexible element 98 and a lower cover resilient flexible element 99 that function like cantilever springs (see FIG. 12A). The right base 6 and left base 7 both have a shelf portion 101. A clipping space between the right cover 4 and the shelf portion 101 of right base 6 can receive the clipping material that the sheath 1 will be clipped to. As the clipping material enters the clipping space between the right cover 4 and the shelf portion 101, the clipping material elastically bends the upper resilient flexible element 98 and the lower resilient flexible element 99 toward the center base 3. The spring energy created from the bending provides a retention force on the clipping material. This retention force creates resistance to sliding the clipping material into and out of the clipping space between the right cover 4 and the shelf portion 101. The thickness and rigidity of the shelf portion 101 helps to provide a spring preload surface for the resilient flexible elements and helps shield them from being damaged. In some embodiments, the shelf portion and cover portion cooperate to define a predetermined maximum gap of the clipping space, thereby restricting insertion of overly thick materials and inhibiting over-deflection of the resilient flexible elements.

The shelf portion 101 includes a plurality of traction boss features 102 that protrude from the shelf portion 101 to create additional resistance by narrowing the gap for the clipping material to go into or out of the sheath clipping mechanism. Both the upper cover resilient flexible element 98 and the lower cover resilient flexible element 99 include a plurality of traction hole features 103 to provide additional resistance to the clipping material sliding into and out of the sheath clipping mechanism (see FIG. 12A). The clipping material may slide into the sheath clipping mechanism until it contacts the clip material stop surface 104 of the right base 6 (see FIG. 12B) or left base 7. Other embodiments of a sheath clipping mechanism may include a single or more than two resilient flexible elements. The shelf portion 101 in other embodiments may be integral to the right base 6 or left base 7 as in this embodiment, or may be components that fasten to the right base 6 or left base 7, or may be integral or fastened to other components of the sheath 1. The lower and upper cover resilient flexible elements in other embodiments may be integral to the right cover 4 or left cover 5 as in this embodiment, or may be separate distinct components that fasten (e.g., mechanically attach via screws or rivets) to the right cover 4 or left cover 5, or may be integral or fastened to other components of the sheath 1. Accordingly, a resilient flexible element may be integral with or attached to a cover portion (and/or other sheath component). Other embodiments may also include lower and upper resilient flexible elements integral to or fastened to the shelf portion 101. Another embodiment may not utilize traction hole features or traction boss features.

While one embodiment of an improved knife and sheath has been described in detail, and other embodiments in less detail, it should be apparent that other modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A sheath and knife system, comprising:
a sheath having at least one follower element and a resilient flexible element;
said resilient flexible element configured to bias said at least one follower element;
a knife having a blade portion and a handle portion, said knife further comprising a retention element protruding from said blade portion configured to engage said at least one follower element;
said sheath defining an opening for receiving said blade portion;
whereby said at least one follower element retains, without locking, said retention element within said sheath.

2. The sheath and knife system of claim 1, wherein said at least one follower element comprises an entry ramp feature and an exit ramp feature configured to contact said retention element, said entry ramp feature and said exit ramp feature meeting at a follower tip.

3. The sheath and knife system of claim 2, wherein said resilient flexible element stores spring energy as said retention element moves along said entry ramp feature toward said follower tip, and wherein said stored spring energy is released as said retention element crosses said follower tip to provide a snap-in force during insertion and a snap-out force during removal, said snap-out force assisting in pushing said knife out of said sheath.

4. The sheath and knife system of claim 1, wherein said sheath defines at least one retention element slot configured to receive said retention element, wherein said at least one retention element slot is sized to constrain relative vertical movement of said retention element within said at least one retention element slot.

5. The sheath and knife system of claim 1, wherein said retention element is removably attached to, or integral with, said blade portion and protrudes from a first side and a second opposing side of said blade portion, and wherein said sheath comprises a right follower element and a left follower element configured to engage said retention element on said first side and said second opposing side, respectively.

6. The sheath and knife system of claim 1, wherein said resilient flexible element acts as a cantilever spring supported by said sheath.

7. The sheath and knife system of claim 1, wherein said sheath further comprises a cover portion configured to cover said blade portion, a shelf portion disposed on an exterior surface of said sheath, and a clipping space located between said cover portion and said shelf portion, and wherein said sheath further comprises a second resilient flexible element positioned within said clipping space, whereby said second resilient flexible element biases a clipping material into engagement with at least one of said cover portion or said shelf portion to retain said clipping material within said clipping space.

8. The sheath and knife system of claim 1, wherein said blade portion comprises at least one bevel, and wherein said sheath further comprises at least one roller disposed within said opening, whereby said at least one roller rotates upon engagement with said at least one bevel as said knife is inserted into and withdrawn from said opening to reduce friction during insertion and withdrawal.

9. A sheath, comprising:
a cover portion configured to cover a blade portion of a knife;
said sheath defining an opening for receiving said blade portion of said knife;
a shelf portion disposed on an exterior surface of said sheath;
a clipping space located between said cover portion and said shelf portion;
said clipping space adapted to receive a clipping material;
at least one resilient flexible element positioned within said clipping space;
whereby said at least one resilient flexible element biases said clipping material into engagement with at least one of said cover portion or said shelf portion to retain said clipping material within said clipping space.

10. The sheath of claim 9, wherein said shelf portion is sufficiently rigid to provide a spring preload surface for said at least one resilient flexible element, and wherein said shelf portion cooperates with said cover portion to define said clipping space with a predetermined maximum gap such that insertion of said clipping material having a thickness greater than said predetermined maximum gap is restricted to inhibit over-deflection of said at least one resilient flexible element.

11. The sheath of claim 9, wherein said sheath comprises an upper resilient flexible element and a lower resilient flexible element disposed within said clipping space.

12. The sheath of claim 9, wherein said shelf portion comprises at least one traction boss feature protruding into said clipping space to create resistance against said clipping material.

13. The sheath of claim 9, wherein said at least one resilient flexible element comprises at least one traction hole feature configured to provide resistance against said clipping material.

14. The sheath of claim 9, further comprising a clip material stop surface configured to limit insertion depth of said clipping material into said clipping space.

15. The sheath of claim 9, further comprising at least one roller disposed within said sheath, wherein said sheath defines a roller pocket configured to receive said at least one roller, and wherein said cover portion comprises a retainer tab configured to retain said at least one roller within said roller pocket, and wherein said sheath further comprises a stop feature positioned to contact a scale feature of said knife to limit forward movement of said knife within said sheath.

16. A sheath and knife system, comprising:
a knife having a blade portion and a handle portion;
a sheath having an opening for receiving said blade portion of said knife;
said blade portion having at least one bevel;
at least one roller disposed within said opening;
whereby said at least one roller rotates upon engagement with said at least one bevel as said knife is inserted into and withdrawn from said opening, thereby reducing friction and facilitating smooth operation.

17. The sheath and knife system of claim 16, comprising a right roller and a left roller disposed on opposing sides of said opening.

18. The sheath and knife system of claim 16, wherein said at least one roller comprises a roller stem feature having an end portion supported by a stem support feature of said sheath, said roller stem feature being sufficiently slender to allow flexure to accommodate thickness variations of said blade portion and to mitigate binding of said blade portion during insertion and withdrawal, and wherein said at least one roller further comprises a pivot head disposed within a pocket pivot feature of said sheath, thereby allowing said at least one roller to pivot during flexure to reduce stress.

19. The sheath and knife system of claim 16, wherein said sheath further comprises a blade spine guide surface configured to constrain vertical movement of said blade portion, and wherein a predetermined amount of clearance is provided to prevent over-constraining said blade portion vertically within said sheath.

20. The sheath and knife system of claim 16, wherein said sheath further comprises a cover portion and a shelf portion defining a clipping space therebetween, and wherein said sheath further comprises at least one resilient flexible element disposed within said clipping space, said at least one resilient flexible element comprising a cantilever spring integral with or attached to said cover portion.
